(19) United States
(12) Patent Application Publication
(10) Pub. No.: US 2026/0135289 A1
(43) Pub. Date: May 14, 2026

(54) RADIO FREQUENCY DEVICES, METHODS FOR MANUFACTURING THEREOF, SYSTEMS, AND WAVEGUIDE ANTENNAS

(71) Applicant: Infineon Technologies AG, Neubiberg (DE)

(72) Inventors: Maciej WOJNOWSKI, Muenchen (DE); Tuncay ERDÖL, Unterhaching (DE); Ernst SELER, Riemerling (DE); Vasileios LIAKONIS, Athens (GR); Walter HARTNER, Bad Abbach (DE); Ioannis PAPANANOS, Vrilissia (GR)

(21) Appl. No.: 19/365,252

(22) Filed: Oct. 22, 2025

(30) Foreign Application Priority Data
Nov. 8, 2024 (DE) 102024210785.9

(51) Int. Cl. H01Q 1/22; H01P 3/12; H01Q 13/10; H01Q 21/00; H01Q 21/06; H01Q 21/24

(52) U.S. Cl. CPC H01Q 1/2283; H01P 3/121; H01Q 13/106; H01Q 21/0087; H01Q 21/06; H01Q 21/24

(57) ABSTRACT

A radio frequency (RF) device includes at least one RF chip, and a structure coupled to the at least one RF chip, wherein the at least one RF chip and the structure are integrated in a same semiconductor package, wherein the structure is configured to couple at least two RF signals of the at least one RF chip to at least two modes of a package-external waveguide and/or vice versa, and wherein the at least two modes are orthogonal to each other.

### CROSS-REFERENCE TO RELATED APPLICATION

This application claims priority to Germany Patent Application No. 102024210785.9 filed on Nov. 8, 2024, the content of which is incorporated by reference herein in its entirety.

### TECHNICAL FIELD

The present disclosure relates to radio frequency (RF) devices, methods for manufacturing RF devices, systems including RF devices, and waveguide antennas.

### BACKGROUND

Radio frequency (RF) transceiver packages may be used in radar systems and feed RF signals directly into air-filled waveguides in order to avoid a routing of the RF signals via transmission lines on a printed circuit board (PCB). A main purpose for this approach is to avoid costs of using high-performance materials in the PCB and to prevent insertion loss of the transmission lines. However, such an approach may suffer from the RF transceiver packages increasing in size, as the interfaces to the waveguides cannot be made arbitrarily small due to existing frequency cutoff behaviors. In particular, with an increasing number of RF channels in radar systems, the described issues may even become more severe.

Manufacturers and developers of RF devices and systems are constantly striving to improve their products. In the above context, it may be desirable to provide RF devices and systems with smaller size and lower production costs without sacrificing device performance. In addition, it may be desirable to provide suitable methods for manufacturing such RF devices and systems and to design waveguide antennas which may be used in this connection.

### SUMMARY

A first aspect of the present disclosure relates to a radio frequency (RF) device. The RF device includes at least one RF chip and a structure coupled to the at least one RF chip, wherein the at least one RF chip and the structure are integrated in a same semiconductor package. The structure is configured to couple at least two RF signals of the at least one RF chip to at least two modes of a package-external waveguide and/or vice versa. The at least two modes are orthogonal to each other.

A second aspect of the present disclosure relates to a waveguide antenna. The waveguide antenna includes a structure configured to couple at least two RF signals associated with at least two different antenna elements of the waveguide antenna to at least two modes of a waveguide of the waveguide antenna and/or vice versa. The at least two modes are orthogonal to each other. The waveguide antenna is configured to transmit and/or receive the at least two RF signals with a same electromagnetic polarization.

A third aspect of the present disclosure relates to a system. The system includes an RF device according to the first aspect, wherein the RF device is coupled to a first end of the package-external waveguide. The system further includes a further structure coupled to a second end of the package-external waveguide, wherein the further structure is configured to couple at least two further RF signals to at least two modes of the package-external waveguide and/or vice versa.

A fourth aspect of the present disclosure relates to a method for manufacturing an RF device. The method includes a step of coupling at least one RF chip and a structure and a step of integrating the at least one RF chip and the structure in a same semiconductor package. The structure is configured to couple at least two RF signals of the at least one RF chip to at least two modes of a package-external waveguide and/or vice versa. The at least two modes are orthogonal to each other.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIGS. 1A-1D schematically illustrating a cross-sectional side view and details of an RF device 100 in accordance with the disclosure.

FIG. 2 schematically illustrates a cross-sectional side view of a system 200 in accordance with the disclosure.

FIG. 3 schematically illustrates a structure 300 which may be included in an RF device in accordance with the disclosure.

FIGS. 4A-4B schematically illustrating orthogonal electromagnetic polarizations (and modes) of a waveguide.

FIGS. 5A-5B schematically illustrating orthogonal electromagnetic polarizations (and modes) of a waveguide.

FIG. 6 schematically illustrates a structure 600 which may be included in an RF device in accordance with the disclosure.

FIG. 7 schematically illustrates a structure 700 which may be included in an RF device in accordance with the disclosure.

FIG. 8 schematically illustrates a structure 800 which may be included in an RF device in accordance with the disclosure.

FIGS. 9A-9B schematically illustrating a structure 900 which may be included in an RF device in accordance with the disclosure.

FIG. 10 schematically illustrates a cross-sectional side view of a system 1000 in accordance with the disclosure.

FIG. 11 schematically illustrates a structure 1100 which may be included in an RF device in accordance with the disclosure.

FIG. 12 schematically illustrates a Vivaldi antenna 1200 and a detail thereof which may be included in an RF device in accordance with the disclosure.

FIGS. 13A-13B schematically illustrating a fan-out area of a fan-out wafer level package.

FIG. 14 illustrates a flowchart of a method for manufacturing an RF device in accordance with the disclosure.

### DETAILED DESCRIPTION

In the following detailed description, reference is made to the accompanying drawings, in which are shown by way of illustration specific aspects in which the disclosure may be practiced. Other aspects may be utilized and structural or logical changes may be made without departing from the concept of the present disclosure. Hence, the following detailed description is not to be taken in a limiting sense, and the concept of the present disclosure is defined by the appended claims.

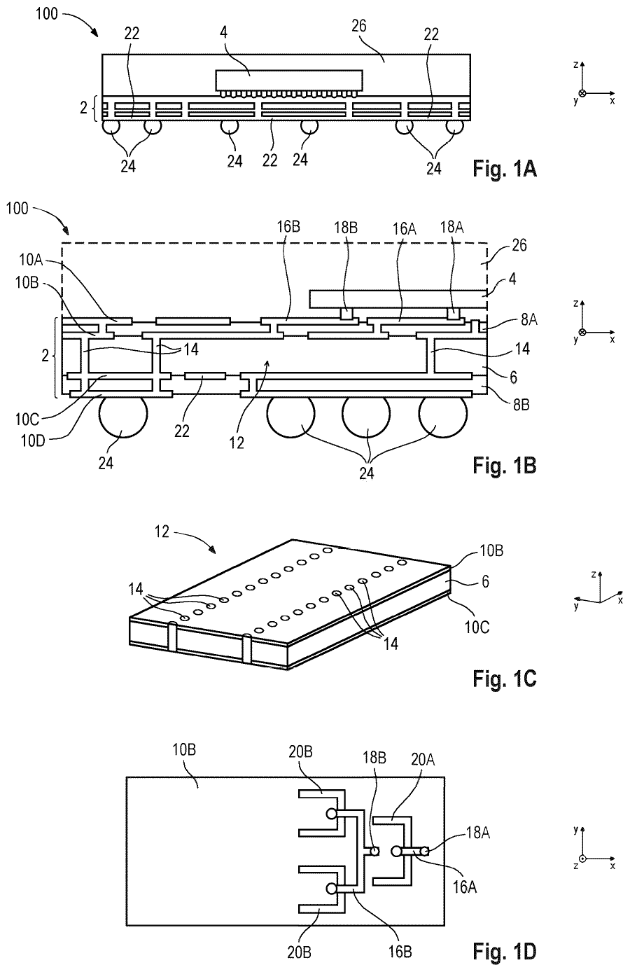

Referring now to FIGS. 1A-1D, a radio frequency (RF) device 100 in accordance with the disclosure and various details thereof are shown. More particular, FIG. 1A shows a cross-sectional side view of the RF device 100, FIG. 1B shows a detail of FIG. 1A, FIG. 1C shows a perspective view of a substrate integrated waveguide (SIW) included in the RF device 100, and FIG. 1D shows a top view of the SIW. The RF device 100 may include a substrate 2 and an RF chip 4 arranged on a top surface of the substrate 2. The RF chip 4 may be made of or may include an arbitrary semiconductor material, such as e.g., silicon. The RF chip 4 (or electronic circuits thereof) may be configured to operate in a frequency range of greater than about 1 GHz, in some examples greater than about 10 GHz. The RF chip 4 may thus also be referred to as radio frequency chip or high frequency chip or microwave frequency chip. More particular, the RF chip 4 may be configured to operate in an RF range or microwave frequency range, which may range from about 1 GHz to about 1 THz, more particular from about 10 GHz to about 300 GHz. Microwave circuits may include, for example, microwave transmitters, microwave receivers, microwave transceivers, microwave sensors, microwave detectors, or the like. RF devices in accordance with the disclosure may be used for radar applications in which the frequency of the RF signals may be modulated. The RF chip 4 may thus also be referred to as radar chip. In particular, the RF chip 4 may include or may correspond to an MMIC (Monolithic Microwave Integrated Circuit).

Radar microwave devices may e.g., be used in automotive, industrial, military and/or defense applications for range and speed measuring systems. For example, automotive applications may include advanced driver assistant systems, automatic vehicle cruise control systems, vehicle anti-collision systems, or the like. Such systems may operate in the microwave frequency range and may utilize FMCW (Frequency Modulation Continuous Wave) signals, for example in the 24 GHz, 76 GHz, or 79 GHz frequency bands. A use of radar microwave systems may provide constant and efficient driving of vehicles. An efficient driving style may, for example, reduce fuel consumption such that CO₂ emission may be reduced and energy savings may be enabled. In addition, abrasion of vehicle tires, brake discs and brake pads may be reduced, thereby reducing fine dust pollution. Improved RF or radar systems, as specified herein, may thus contribute to green technology solutions, e.g., climate-friendly solutions providing reduced energy usage.

As can be seen from the detail of FIG. 1B, the substrate 2 may include a substrate core 6 and at least one prepreg layer 8 arranged on the substrate core 6. In the illustrated example, the substrate core 6 may be embedded between a first prepreg layer 8A arranged on the top surface of the substrate core 6 and a second prepreg layer 8B arranged on the bottom surface of the substrate core 6. The substrate core 6 and the prepreg layers 8A, 8B may include or may correspond to a dielectric material. The substrate core 6 and the prepreg layers 8A, 8B may substantially extend in the x-y-plane. The substrate core 6 and the prepreg layers 8A, 8B may be made of a same material or may differ in their material composition. For example, each of the substrate core 6 and the prepreg layers 8A, 8B may be made of or may include one or multiple dielectric glue layers. The substrate 2 may include a plurality of metal layers 10A to 10D that may be arranged on different levels with respect to the z-direction. In the illustrated example, the substrate 2 may include a first metal layer 10A arranged on the top surface of the first prepreg layer 8A, a second metal layer 10B arranged between the first prepreg layer 8A and the substrate core 6, a third metal layer 10C arranged between the substrate core 6 and the second prepreg layer 8B and a fourth metal layer 10D arranged on the bottom surface of the second prepreg layer 8B. Each of the metal layers 10A to 10D may be at least partially structured.

In the illustrated example, the RF device 100 may include a package-internal transmission structure in form of a package-internal SIW 12 which may be arranged in the substrate core 6. In further examples, the SIW 12 may be replaced by an air-filled waveguide. The SIW 12 may include the metal layers 10B and 10C as well as the substrate core 6 arranged between the metal layers 10B and 10C. In addition, the SIW 12 may include a plurality of metallic vias (or via connections) 14 extending between the metal layers 10B and 10C. The metallic vias 14 may be arranged to form a via fence as can be seen from the perspective view of FIG. 1C. The SIW 12 may be formed by the substrate core 6 covered on both faces by the metal layers 10B and 10C. The substrate core 6 may embed the metallic vias 14 that may form two parallel rows of metallic via holes 14 delimiting a propagation area of RF signals (e.g., electromagnetic waves) that are to be transmitted via the SIW 12. The propagating electromagnetic waves may be confined within the substrate core 6 by the metal layers 10B and 10C on each of the two surfaces of the substrate core 6 as well as between the two rows of metallic vias 14 connecting the metal layers 10B and 10C. In the illustrated example, the SIW 12 may be configured to transmit electromagnetic waves in a lateral direction, e.g., in the x-y-plane.

The RF device 100 may include a package-internal transmission structure in form of a first package-internal planar transmission line 16A which may be arranged on the top surface of the substrate 2. The first planar transmission line 16A may be at least partially formed in the first metal layer 10A and may be configured to couple a first electrical connection element 18A of the RF chip 4 and the SIW 12. For example, the first planar transmission line 16A may include or may correspond to at least one of a microstrip line, a coplanar waveguide, a ground-signal-ground line, or the like. As can be seen from the top view of FIG. 1D, the first planar transmission line 16A formed in the first metal layer 10A may cross a first slot 20A formed in the second metal layer 10B. In the illustrated example, the first slot 20A may be formed in a u-shape. That is, in the top view of FIG. 1D, the shape of the first slot 20A may resemble the shape of the letter “U”. In further examples, the first slot 20A may be formed differently, such as e.g., in a v-shape or in a c-shape. The first slot 20A may be configured to couple a signal from the first planar transmission line 16A crossing the first slot 20A into the SIW 12. In a similar fashion, the first slot 20A may be configured to couple a signal from the SIW 12 into the first planar transmission line 16A.

The RF device 100 may include a package-internal transmission structure in form of a second package-internal planar transmission line 16B which may be arranged on the top surface of the substrate 2. The second planar transmission line 16B may be at least partially similar to the first planar transmission line 16A. The second planar transmission line 16B may be at least partially formed in the first metal layer 10A and may be configured to couple a second electrical connection element 18B of the RF chip 4 and the SIW 12. The second planar transmission line 16B may include or may correspond to at least one of a microstrip line, a coplanar waveguide, a ground-signal-ground line, or the like. As can be seen from the top view of FIG. 1D, the second planar transmission line 16B formed in the first metal layer 10A may split into two signal lines, wherein each of the two signal lines may cross one of two second slots 20B formed in the second metal layer 10B. In the illustrated example, the second slots 20B may be u-shaped similar to the first slot 20A, but are not limited thereto. The second slots 20B may be configured to couple a signal from the second planar transmission line 16B crossing both second slots 20B into the SIW 12. In a similar fashion, the second slots 20B may be configured to couple a signal from the SIW 12 into the second planar transmission line 16B.

The RF device 100 may include at least one launcher 22 arranged in the substrate 2 and configured to couple RF signals into or out of the RF package 100 (or more particular the substrate 2). In the example detail of FIG. 1B, a single launcher 22 is shown, but it is to be understood that the RF device 100 may include an arbitrary number of launchers depending on the specific design of the RF device 100. The launcher 22 may also be referred to as transmission/reception element. In some examples, the launcher 22 may include or may correspond to one or multiple antennas (such as e.g., patch antennas) which may e.g., be formed in one or more of the metal layers 10. In the illustrated example, the launcher 22 may be arranged at the bottom surface of the substrate 2 and may be configured to transmit and/or receive RF signals in a substantially vertical direction. In further examples, a launcher of the RF device 100 may be arranged at a side surface of the substrate 2 and may be configured to transmit and/or receive RF signals in a lateral direction.

As already discussed, the RF device 100 may be configured to transmit and/or receive RF signals. In the following, an example transmission mode of the RF device 100 is described. It is to be understood that a reception mode of the RF device 100 may be based on a similar transport of RF signals, but in the opposite direction. In the transmission mode, a first RF signal that is to be transmitted by the RF device 100 may be provided from the RF chip 4 to the first planar transmission line 16A at the first electrical connection element 18A. For example, the first RF signal may be associated with a first RF transmission (TX) channel of the RF chip 4. The first RF signal may be coupled from the first planar transmission line 16A into the SIW 12. Here, coupling the first RF signal from the first planar transmission line 16A into the SIW 12 may be based on electromagnetic excitation. That is, the first slot 20A may be configured to excite a first RF electromagnetic wave in the SIW 12 based on the first RF signal transmitted via the first planar transmission line 16A. In particular, a first mode of the SIW 12 may be excited, wherein the first mode may include or may correspond to a first electromagnetic polarization of the SIW 12. In the illustrated example, the first excited mode may e.g., correspond to the TE10 mode of the SIW 12.

In a similar fashion, a second RF signal that is to be transmitted by the RF device 100 may be provided from the RF chip 4 to the second planar transmission line 16B at the second electrical connection element 18B. The second RF signal may be associated with a second RF TX channel of the RF chip 4. In particular, the second TX channel may differ from the first TX channel previously described. The second RF signal may be coupled from the second planar transmission line 16B into the SIW 12 based on electromagnetic excitation. Here, the two second slots 20B may be configured to excite a second RF electromagnetic wave in the SIW 12 based on the second RF signal transmitted via the second planar transmission line 16B. In particular, a second mode of the SIW 12 may be excited, wherein the second mode may include or may correspond to a second electromagnetic polarization of the SIW 12. The second mode and the first mode of the SIW 12 may be orthogonal to each other. In the illustrated example, the second excited mode may e.g., correspond to the TE20 mode of the SIW 12 which is orthogonal to the TE10 mode of the SIW 12.

In this regard, it is to be noted that orthogonal modes of a waveguide may be specified as modes that are mathematically orthogonal to each other in the context of electromagnetic field distributions. Such orthogonality may mean that the integral of the product of the field distributions of two different modes over the entire cross-sectional area of the waveguide is zero. Stated differently, orthogonal modes of a waveguide may be independent of one another, and their electric and magnetic field patterns do not overlap in a way that would allow them to interfere with each other during propagation. For example, in case of a rectangular waveguide, two modes of the same type (TEₘₙ or TMₘₙ) may be specified as orthogonal provided that the mode indices are not the same, e.g., (m₁, n₁)≠(m₂, n₂). For instance, TE11, TE10, TE20 are all orthogonal to each other.

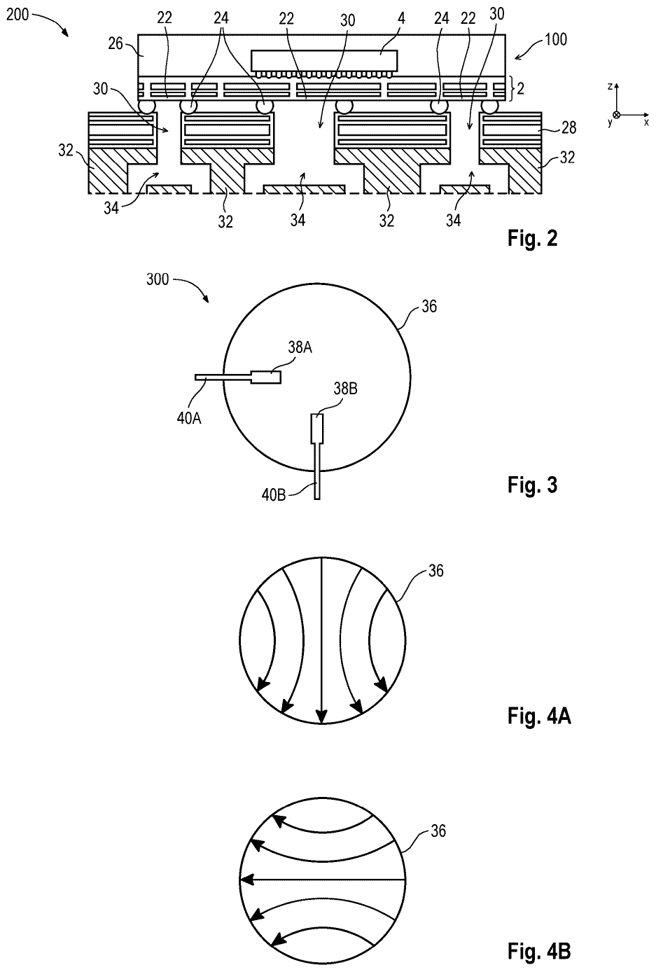

According to the above the two RF signals transmitted by the planar transmission lines 16A, 16B may be combined in a signal including two orthogonal modes. The two orthogonal modes may then be transmitted to the launcher 22 via the SIW 12. The launcher 22 may be configured to couple the two orthogonal modes to two modes of a package-external waveguide (not shown), wherein the two modes of the package-external waveguide may be orthogonal to each other as well. Accordingly, the launcher 22 may be shared between two channels of the RF chip 4. The RF signals from different channels of the RF chip 4 may be transmitted in the package-external waveguide using different orthogonal modes and can be separated again later on (e.g., in a waveguide antenna) for further processing. It is to be understood that the package-external waveguide is not restricted to a specific type. For example, the package-external waveguide may include or may correspond to at least one of a metal waveguide, a substrate integrated waveguide, an air-filled waveguide, a dielectric waveguide, a plastic microwave fiber, etc. A non-limiting example of coupling RF signals into two orthogonal modes of a package-external waveguide is shown and described in connection with FIG. 2 in which the package-external waveguide may exemplarily correspond to a waveguide antenna.

According to the above the SIW 12 and the launcher 22 may form or correspond to a structure configured to couple two RF signals of the RF chip 4 to at least two modes of a package-external waveguide and/or vice versa. The structure may also be referred to as interface. The structure may represent a combiner configured to combine the two RF signals of the RF chip 4 to a combined signal. More particular, the two RF signals transmitted by the planar transmission lines 16A, 16B may be combined to the signal transmitted by the SIW 12 and including two orthogonal modes. In addition, the launcher 22 as part of the structure may be configured to couple the combined signal from the SIW 12 to the at least two modes of the package-external waveguide and/or vice versa.

The RF device 100 may outperform other RF devices. The RF device 100 may only require a single launcher 22 to couple two RF signals of the RF chip 4 into a package-external waveguide and/or vice versa. In contrast to this, in other RF devices, only a single RF signal is coupled into a package-external waveguide using a launcher. Accordingly, the number of launchers required in the RF device 100 may be smaller compared to other RF devices. Due to the reduced number of required launchers, the RF device 100 may be of smaller size such that fabrication costs may be lowered. In addition, the RF device 100 may be capable of providing a larger number of RF channels at a same size, thereby improving a device performance.

In the illustrated and non-limiting example of FIGS. 1A-1D, the RF device 100 is shown to include only a single RF chip 4. However, it is to be understood that the RF device 100 may include an arbitrary number of RF chips which may depend on the specific design of the RF device 100. Furthermore, in the shown case, two RF signals of a same RF chip 4 may be combined and coupled into a package-external waveguide. In further examples, RF signals of different chips may be combined and coupled into a package-external waveguide. In addition, in the illustrated example, only two modes of the SIW 12 and the package-external waveguide may be used for signal transmission. In further examples, it may also be possible to use more than two orthogonal modes for a transmission and/or reception of RF signals by the RF device 100.

The RF device 100 may include further components which are described in the following. For example, the RF device 100 may optionally include connection elements 24 configured to connect the RF device 100 to an external component, such as e.g., a printed circuit board (PCB) as will be described in connection with FIG. 2. In the illustrated example, the connection elements 24 may include or may correspond to solder balls or solder depots, but are not restricted thereto. Furthermore, the RF device 100 may optionally include an encapsulation material 26 which may at least partially encapsulate components of the RF device 100. In the illustrated example, the encapsulation material 26 may be arranged on the top surface of the substrate 2 and may at least partially cover the RF chip 4. The encapsulation material 26 may include or may be made of at least one of an epoxy, a filled epoxy, a glass fiber filled epoxy, an imide, a thermoplast, a thermoset polymer, a polymer blend, a mold compound, or the like. Various techniques may be used for encapsulating components of the RF device 100 in the encapsulation material 26, for example at least one of compression molding, injection molding, powder molding, liquid molding, map molding, or the like. The RF device 100 may also be referred to as package or semiconductor package or RF package or RF semiconductor package. Note that the RF chip 4 and the structure for coupling the RF signals of the RF chip 4 to the orthogonal modes of a package-external waveguide may particularly be arranged in the same semiconductor package.

Referring now to FIG. 2, a system (or RF system) 200 in accordance with the disclosure is shown. The system 200 may include an RF device 100 which may be similar to the RF device 100 of FIGS. 1A-1D and may include some or all features of it. The system 200 may include a PCB 28, wherein the RF device 100 may be mounted on the top surface of the PCB 28. A mechanical and electrical connection between a substrate 2 of the RF device 100 and the top surface of the PCB 28 may be established by multiple electrical connections elements 24 arranged at the bottom surface of the substrate 2, such as e.g., solder balls or solder depots. The PCB 28 may include multiple openings 30 extending through the PCB 28 in a substantially vertical direction. The openings 30 may be aligned with launchers 22 of the RF device 100 arranged at the bottom surface of the substrate 2. Each of the launchers 22 may be coupled to at least two RF ports of the RF chip 4 as previously described in connection with the example of FIGS. 1A-1D.

The system 200 may include a package-external waveguide which may be arranged at the bottom surface of the PCB 28. In the illustrated example, the package-external waveguide may include or may correspond to a waveguide antenna 32 mounted on the bottom surface of the PCB 28. Stated differently, the RF device 100 may be coupled to a first upper end of the waveguide antenna 32 via the PCB 28. The waveguide antenna 32 may include a plurality of air-filled waveguides 34 formed in the waveguide antenna 32. In one example, the waveguide antenna 32 may include or may correspond to an air-filled plastic waveguide antenna. Similar to the launchers 22 of the RF device 100 the air-filled waveguides 34 of the waveguide antenna 32 may be aligned with the openings 30 of the PCB 28. As a result, each of the air-filled waveguides 34 facing the bottom surface of the PCB 28 may be arranged opposite to a launcher 22 facing the top surface of the PCB 28. Each of the launchers 22 may be configured to couple an RF signal including at least two orthogonal modes between the RF device 100 and an air-filled waveguide 34 of the waveguide antenna 32. Here, the respective opening 30 of the PCB 28 connecting the respective launcher 22 with the respective opposite air-filled waveguide 34 may be configured for transferring the at least two orthogonal modes between the launcher 22 and the air-filled waveguide 34 aligned with the opening 30.

The waveguide antenna 32 may include a structure (not illustrated) configured to couple two modes of a waveguide 34 of the waveguide antenna 32 to two RF signals associated with two different antenna elements of the waveguide antenna 32. The structure may be arranged at a second lower end of the waveguide antenna 32. In other words, the structure may be configured to couple an RF signal including two orthogonal modes and transmitted via an air-filled waveguide 34 to two RF signals associated with the two antenna elements of the waveguide antenna 32. For example, the two antenna elements may include or may correspond to two slots formed in the waveguide antenna 32. The two antenna elements may be configured to transmit or radiate the two RF signals. It is to be understood that each of the air-filled waveguides 34 may be associated with a structure as described such that each RF signal including two orthogonal modes and transported via a respective air-filled waveguide 34 may be coupled to two RF signals which may then be transmitted via the respective two antenna elements.

It is to be understood that the system 200 may be configured to receive RF signals in a similar fashion. In a reception mode, two antenna elements of an air-filed waveguide 34 may receive RF signals and the structure of the waveguide antenna 32 may couple the two received RF signals associated with the two different antenna elements of the waveguide antenna 32 to at least two orthogonal modes of the air-filled waveguide 34. The RF signal including the two orthogonal modes may be forwarded to the respective launcher 22 arranged opposite to the air-filled waveguide 34. The launcher 22 may couple the two orthogonal modes into the RF device 100 as previously described in connection with the example of FIGS. 1A-1D. It is to be noted that the waveguide antenna 32 may be configured to transmit and/or receive the two RF signals with a same electromagnetic polarization.

Referring now to FIGS. 3A and 3B, a structure 300 which may be included in an RF device in accordance with the disclosure is shown. Similar to previous examples, the structure 300 may be configured to couple two RF signals of at least one RF chip to two modes of a package-external waveguide and/or vice versa. In the shown case, the package-external waveguide may exemplarily include or correspond to a circular waveguide 36. The structure 300 may include a first probe antenna 38A and a second probe antenna 38B arranged orthogonal to the first probe antenna 38A. The first probe antenna 38A may be connected to an RF chip (not illustrated) via a first signal line 40A, wherein the first probe antenna 38A may be associated with a first channel of the RF chip. In a similar fashion, the second probe antenna 38B may be connected to the same (or a different) RF chip via a second signal line 40B, wherein the second probe antenna 38B may be associated with a second channel of the same (or different) RF chip. The second channel may be different from the first channel associated with the first probe antenna 38A.

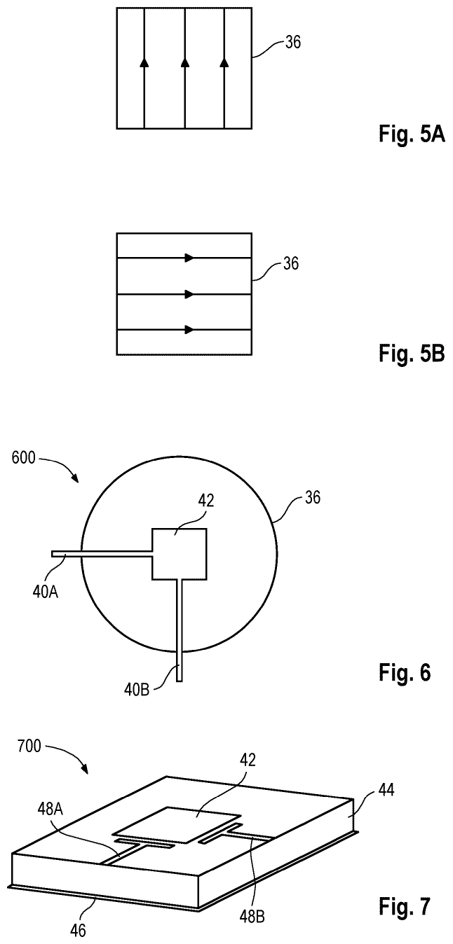

The first probe antenna 38A may be configured to excite a first electromagnetic polarization of the waveguide 36, while the second probe antenna 38B may be configured to excite a second electromagnetic polarization of the waveguide 36 orthogonal to the first electromagnetic polarization. Electric field lines of two example orthogonal modes of a circular waveguide 36 are shown in FIGS. 4A and 4B. The structure 300 may thus provide two functionalities, namely combining the two RF signals of the at least one RF chip to a combined signal and coupling the combined signal to the two modes of the waveguide 36. It is to be understood that the structure 300 may be configured to receive RF signals in a similar fashion, e.g., an RF signal including two orthogonal modes of the waveguide 36 may be received by the probe antennas 40A, 40B and coupled to the signal lines 40A, 40B. It is noted that the waveguide 36 is not restricted to a circular shape. In further examples, the circular waveguide 36 may be replaced by a rectangular waveguide. Electric field lines of two example orthogonal modes of a rectangular waveguide 36 are shown in FIGS. 5A and 5B. Similar to previous examples, an RF device in accordance with the disclosure including the structure 300 may outperform other RF devices as described before in connection with FIGS. 1A-1D and 2.

Referring now to FIG. 6, a structure 600 which may be included in an RF device in accordance with the disclosure is shown. Similar to previous examples, the structure 600 may be configured to couple two RF signals of at least one RF chip to two modes of a package-external waveguide and/or vice versa. In the shown case, the package-external waveguide may exemplarily include or may correspond to a circular waveguide 36. The structure 600 may include a patch antenna 42 which may be connected to at least one RF chip (not illustrated) via a first signal line 40A associated with a first channel of the at least one RF chip and via a second signal line 40B associated with a second channel of the at least one RF chip. The patch antenna 42 may be configured to excite a first electromagnetic polarization of the waveguide 36 and to excite a second electromagnetic polarization of the waveguide 36 orthogonal to the first electromagnetic polarization. Electric field lines of two example orthogonal modes of a circular waveguide 36 are shown in FIGS. 4A and 4B.

Referring now to FIG. 7, a structure 700 which may be included in an RF device in accordance with the disclosure is shown. Similar to previous examples, the structure 700 may be configured to couple two RF signals of at least one RF chip to two modes of a package-external waveguide and/or vice versa. The structure 700 may include a dielectric material 44, a ground plane 46 arranged at the bottom surface of the dielectric material 44 and a patch antenna 42 arranged at the top surface of the dielectric material 44. The structure 700 may further include two T-shaped microstrip transmission lines 48A, 48B configured to feed the square patch antenna 42 through electromagnetic coupling from two orthogonal edges. The two transmission lines 48A, 48B may be associated with two channels of the at least one RF chip. For example, the structure 700 may be arranged in a package similar to the example of FIGS. 1A-1D. More particular, the structure 700 may be integrated in the substrate 2 of FIGS. 1A-1D. A package-external waveguide (not illustrated) may be arranged above the patch antenna 42 such that the patch antenna 42 may be configured to excite two orthogonal electromagnetic polarizations of the package-external waveguide.

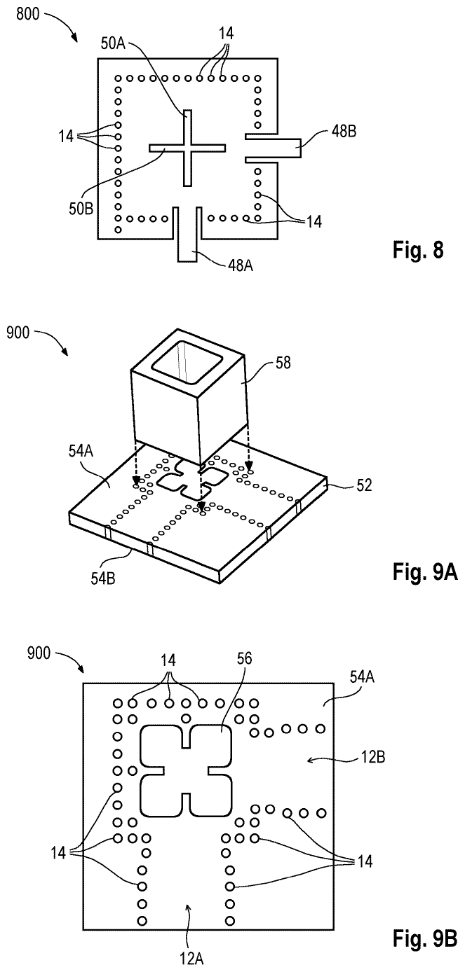

Referring now to FIG. 8, a structure 800 which may be included in an RF device in accordance with the disclosure is shown. Similar to previous examples, the structure 800 may be configured to couple two RF signals of at least one RF chip to two modes of a package-external waveguide and/or vice versa. For example, the structure 800 may be arranged in a package similar to the example of FIGS. 1A-1D. The structure 800 may include a slot antenna having a first slot 50A and a second slot 50B arranged orthogonal to the first slot 50A. For example, the slot antenna may be an SIW cavity backed slot antenna. The slot antenna may be fed by two separate signal lines 48A, 48B (such as e.g., at least one of a coplanar waveguide, a microstrip line, or the like), which may be connected to one or more RF chips (not illustrated) and associated with two channels of the RF chip(s). A package-external waveguide (not illustrated) may be arranged above the slot antenna such that the slot antenna may be configured to excite two orthogonal electromagnetic polarizations of the package-external waveguide. In the illustrated example, a plurality of metallic vias 14 forming a via fence may surround the slot antenna. The metallic vias 14 may implement four sidewalls of an SIW cavity backing the slot antenna.

Referring now to FIGS. 9A and 9B, a perspective view and a top view of a structure 900 which may be included in an RF device in accordance with the disclosure are shown. Similar to previous examples, the structure 900 may be configured to couple two RF signals of at least one RF chip to two modes of a package-external waveguide and/or vice versa. The structure 900 may include a dielectric material 52, a first metal layer 54A arranged on a top surface of the dielectric material 52 and a second metal layer 54B arranged on a bottom surface of the dielectric material 52. An opening 56 may be formed in the first metal layer 54A. In the illustrated example, the opening 56 may have the shape of a square with four notches arranged approximately at the centers of the four sides of the square. The notches may extend in a direction towards the center of the square. The opening 56 may form an antenna similar to the cross-shaped slot antenna of FIG. 8 having similar radiation properties. The antenna formed by the opening 56 may be fed by two separate SIWs 12A, 12B, which may be connected to one or more RF chips (not illustrated) and associated with multiple channels of the RF chip(s). The structure 900 may include a plurality of metallic vias 14 extending through the dielectric material 52 and surrounding the SIWs 12A, 12B and the opening 56. A package-external waveguide 58 may be arranged above the opening 56 such that two orthogonal electromagnetic polarizations of the waveguide 58 may be excited by the antenna formed by the opening 56. For example, the structure 900 may be arranged in a package similar to the example of FIGS. 1A-1D. In this context, the structure 900 may be particularly integrated in the substrate 2 of the RF device 100.

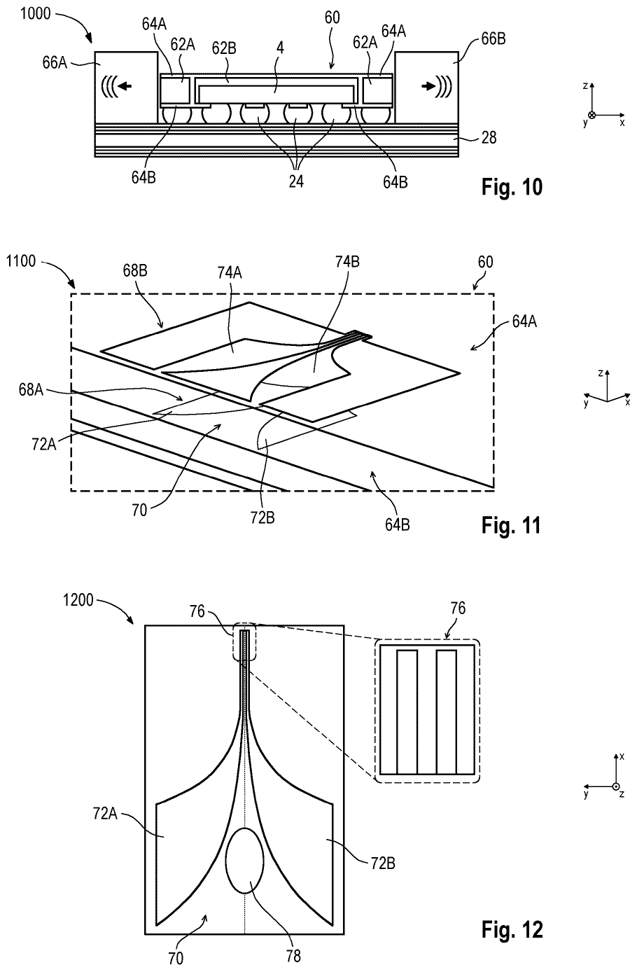

Referring now to FIG. 10, a system (or RF system) 1000 in accordance with the disclosure is shown. The system 1000 may include a PCB 28 and an RF package 60 arranged on the top surface of the PCB 28. In the illustrated example, the RF package 60 may be mechanically and electrically connected to the top surface of the PCB 28 using multiple connection elements 24. The RF package 60 may include at least one RF chip 4 which may be electrically accessible via the connection elements 24. In the illustrated example, the RF chip 4 may be embedded or encapsulated in one or multiple encapsulation materials 62A, 62B. The RF package 60 may include a first metal layer 64A arranged on the top surface of the RF package 60 and a second metal layer 64B arranged on the bottom surface of the RF package 60. The system 1000 may further include at least one package-external waveguide. In the illustrated example, the system 1000 may include an example number of two plastic microwave fibers (PMF) 66A, 66B that may be arranged laterally next to the RF package 60. The RF package 60 may include a structure coupled to the RF chip 4, wherein the RF chip 4 and the structure may be integrated in the same semiconductor package. The structure may be configured to couple at least two RF signals of the at least one RF chip 4 to at least two modes of one or both of the PMFs 66A, 66B and/or vice versa, wherein the at least two modes may be orthogonal to each other. In the example side view of FIG. 10, the structure is not shown for the sake of simplicity. An example of such a structure is shown and described in the following with regard to FIG. 11.

Referring now to FIG. 11, a structure 1100 which may be included in an RF device in accordance with the disclosure is shown. For example, the structure 1100 may be included in the RF package 60 of FIG. 10 and may be configured to couple at least two RF signals of at least one RF chip to at least two modes of a package-external waveguide and/or vice versa. The structure 1100 may include a first antenna 68A configured to transmit and/or receive a first RF signal having a first electromagnetic polarization and a second antenna 68B configured to transmit and/or receive a second RF signal having a second electromagnetic polarization orthogonal to the first electromagnetic polarization. In the illustrated example, the first antenna 68A may be formed in a first metal layer 64B arranged at the bottom surface of the semiconductor package 60, and the second antenna 68B may be formed in a second metal layer 64A arranged at the top surface of the semiconductor package 60.

The two antennas 68A, 68B may be configured to transmit two RF signals simultaneously in two orthogonal (and thus independent) polarizations in a lateral direction, for example in the x-direction. The two RF signals may be coupled into a PMF as previously described in connection with the example of FIG. 10. Each of the two antennas 68A, 68B may be connected to one or multiple RF chips (not illustrated) providing the RF signals that are to be coupled into the PMF. A connection between the antennas 68A, 68B and the RF chip(s) is not shown for the sake of simplicity. It is to be understood that the two antennas 68A, 68B may also be configured to simultaneously receive two RF signals via the PMF in two orthogonal polarizations. Here, the structure 1100 may be configured to couple at least two modes of the PMF to at least two RF signals of the at least one RF chip.

The RF package 60 and the system 1000 of FIG. 10 including the structure 1100 of FIG. 11 may outperform other RF devices. Based on the presented concept a solution for realizing broadband package-to-PMF interconnections for a high-speed communication over PMF may be provided. The proposed solution may provide a high lateral directivity radiation pattern, thereby providing a very efficient RF chip to PMF coupling solution. This solution may outperform other approaches that only use single antennas integrated on a PCB or in a package, wherein the single antennas transmit only one RF signal into a PMF using only one polarization (or mode). The solution presented in FIGS. 10 and 11 may allow to effectively double a data transmission rate keeping the same signal bandwidth, thus relaxing requirements on integrated circuits and overcoming dispersion limitations of PMF links.

In the illustrated example of FIG. 11, the first antenna 68A may include or may correspond to a first Vivaldi antenna, while the second antenna 68B may include or may correspond to a second Vivaldi antenna. However, it is to be understood that the presented concepts are not restricted to a specific antenna type. In further examples, the antennas 68A, 68B may include or may correspond to other types of antennas, such as e.g., patch antennas, slot antennas, Uda-Yagi antennas, etc. The first Vivaldi antenna 68A arranged at the bottom surface of the package 60 may have a long, tapered slot 70 arranged between two portions (or traces) 72A, 72B of the first Vivaldi antenna 68A. The slot 70 may start narrow at one end and may gradually widen towards the other end. The geometric shape of the second Vivaldi antenna 68B arranged at the top surface of the package 60 may be complementary (or inverted) to the geometric shape of the first Vivaldi antenna 68A. In this context, the portions 72A, 72B of the first Vivaldi antenna 68A may (in particular exactly) fit into gaps 74A, 74B of the second Vivaldi antenna 68B when viewed in a direction substantially perpendicular to the top surface of the package 60, e.g., when viewed in the z-direction. Due to their complementary geometric shapes the Vivaldi antennas 68A, 68B may be configured to transmit two RF signals having orthogonal electromagnetic polarizations. Each of the two Vivaldi antennas 68A, 68B may have its own ground plane reference in order to provide an appropriate isolation. In addition, an appropriate distance between the two Vivaldi antennas 68A, 68B may be required in order to reduce the generation of strong secondary current density sources. The complementary second Vivaldi antenna 68B may be fed with a simple microstrip line. In contrast to this, the first Vivaldi antenna 68A may require a differential input, which may e.g., be provided by a Marchand balun.

Referring now to FIG. 12, a Vivaldi antenna 1200 and a detail thereof are shown which may be included in an RF device in accordance with the disclosure. For example, the Vivaldi antenna 1200 may correspond to the first Vivaldi antenna 68A in FIG. 11. The Vivaldi antenna 1200 may include two portions 72A, 72B and a long, tapered slot 70 arranged in between. The slot 70 may start narrow at one end and may gradually widen towards the other end. In the shown case, an input 76 of the Vivaldi antenna 1200 may be differential. For example, the Vivaldi antenna 1200 may be fed by a differential coplanar strip line which may comply with cases in which IC blocks of the connected RF chip(s) are differential such that the RF signals of the RF chip(s) may be appropriately fed to the Vivaldi antenna 1200. In single-mode setups, an on-chip or in-package balun may be required. The Vivaldi antenna 1200 may optionally include a metal reflector 78 which may be arranged between the two portions 72A, 72B of the Vivaldi antenna 1200 for improving antenna directivity of the Vivaldi antenna 1200.

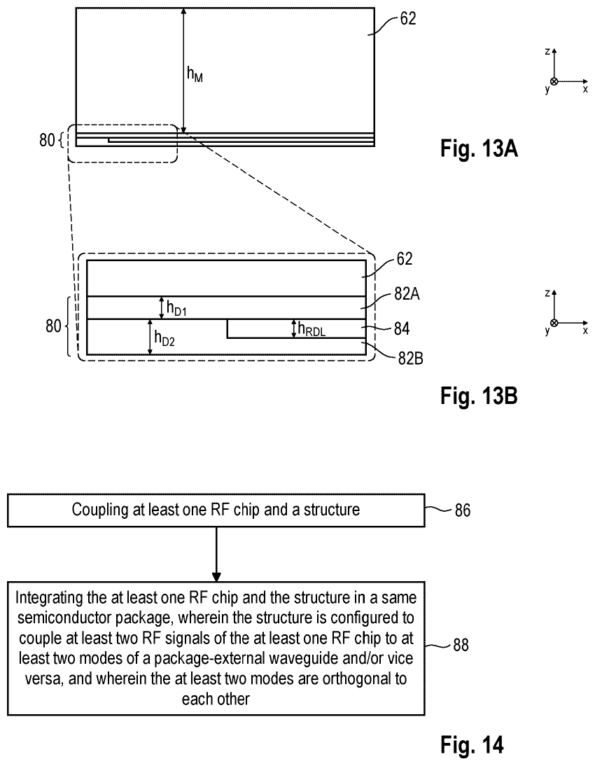

Referring now to FIGS. 13A and 13B, a fan-out area of a fan-out wafer level package is shown. For example, the RF package 60 of FIGS. 10 and 11 may correspond to a fan-out wafer level package including a fan-out area, such as e.g., an eWLB (Embedded Wafer Level Ball Grid Array) package. However, it is to be understood that the concepts presented herein are not restricted to a specific package type. In a further example, the RF package 60 may correspond to a Flip Chip Ball Grid Array (FCBGA) package. FIG. 13A shows an encapsulation material 62 (e.g., a mold compound), wherein an electrical redistribution structure 80 may be arranged on the bottom surface of the encapsulation material 62. FIG. 13B shows a detail of the electrical redistribution structure 80 which may include one or more dielectric layers 82 and one or more metal layers 84. In the illustrated example, an example number of two dielectric layers 82A, 82B and a single metal layer 84 are shown for the sake of simplicity, but the number of layers may differ in further examples depending on the specific design of the considered device. In one example, the metal layer 84 of FIGS. 13A and 13B may correspond to the metal layer 64 of FIG. 10.

Referring now back to the example of FIG. 11, the first antenna 68A and the second antenna 68B of the structure 1100 may be formed in electrical redistribution structures arranged on the semiconductor package 60 similar to the electrical redistribution structure 80 of FIG. 13. That is, the RF package 60 of FIGS. 10 and 11 may be a fan-out wafer level package, wherein the first antenna 68A and the second antenna 68B may be arranged in a fan-out area of the fan-out wafer level package. In particular, the encapsulation material 62 may have low dielectric losses such that a placement of the antennas 68A, 68B above the encapsulation material 62 in the fan-out area may be particularly beneficial.

FIG. 14 illustrates a flowchart of a method for manufacturing an RF device in accordance with the disclosure. The method may be used for manufacturing RF devices as previously described and may thus be read in connection with previous figures. The method of FIG. 14 is described in a general manner in order to qualitatively specify aspects of the disclosure. It is to be understood that the method may include further aspects. For example, the method may be extended by any of the aspects described in connection with other examples in accordance with the disclosure.

At 86, at least one RF chip and a structure may be coupled. At 88, the at least one RF chip and the structure may be integrated in a same semiconductor package. The structure may be configured to couple at least two RF signals of the at least one RF chip to at least two modes of a package-external waveguide and/or vice versa. The at least two modes may be orthogonal to each other.

### EXAMPLES

The examples described herein provide RF devices, methods for manufacturing RF devices, systems including RF devices, and waveguide antennas.
Example 1 is a radio frequency (RF) device, comprising: at least one RF chip; and a structure coupled to the at least one RF chip, wherein the at least one RF chip and the structure are integrated in a same semiconductor package, wherein the structure is configured to couple at least two RF signals of the at least one RF chip to at least two modes of a package-external waveguide and/or vice versa, and wherein the at least two modes are orthogonal to each other.
Example 2 is an RF device of Example 1, wherein the structure comprises a combiner configured to combine the at least two RF signals of the at least one RF chip to a combined signal and a launcher configured to couple the combined signal to the at least two modes of the package-external waveguide and/or vice versa.
Example 3 is an RF device of Example 1 or 2, wherein the at least two RF signals are associated with at least two different RF channels of the at least one RF chip.
Example 4 is an RF device of any of the preceding Examples, wherein the at least two modes comprise at least two orthogonal electromagnetic polarizations of the package-external waveguide.
Example 5 is an RF device of any of the preceding Examples, wherein the structure comprises: a first antenna configured to transmit and/or receive a first RF signal having a first electromagnetic polarization, and a second antenna configured to transmit and/or receive a second RF signal having a second electromagnetic polarization orthogonal to the first electromagnetic polarization.
Example 6 is an RF device of Example 5, wherein: the first antenna is formed in a first metal layer arranged at a first main surface of the semiconductor package, and the second antenna is formed in a second metal layer arranged at a second main surface of the semiconductor package opposite the first main surface.
Example 7 is an RF device of Example 5 or 6, wherein a geometric shape of the first antenna is complementary to a geometric shape of the second antenna.
Example 8 is an RF device of any of Examples 5 to 7, wherein the first antenna and the second antenna are formed in an electrical redistribution structure of the semiconductor package.
Example 9 is an RF device of any of Examples 5 to 8, wherein the semiconductor package is a fan-out wafer level package and the first antenna and the second antenna are arranged in a fan-out area of the fan-out wafer level package.
Example 10 is an RF device of any of Examples 5 to 9, wherein the first antenna comprises a first Vivaldi antenna and the second antenna comprises a second Vivaldi antenna.
Example 11 is an RF device of any of the preceding Examples, wherein the structure comprises: a first probe antenna configured to excite a first electromagnetic polarization of the package-external waveguide, and a second probe antenna arranged orthogonal to the first probe antenna and configured to excite a second electromagnetic polarization of the package-external waveguide orthogonal to the first electromagnetic polarization.
Example 12 is an RF device of any of the preceding Examples, wherein the structure comprises: a patch antenna configured to excite a first electromagnetic polarization of the package-external waveguide and to excite a second electromagnetic polarization of the package-external waveguide orthogonal to the first electromagnetic polarization.
Example 13 is an RF device of any of the preceding Examples, wherein the structure comprises: a slot antenna comprising a first slot and a second slot arranged orthogonal to the first slot.
Example 14 is an RF device of any of the preceding Examples, further comprising: at least one package-internal transmission structure coupled between the at least one RF chip and the structure, wherein the at least one package-internal transmission structure is configured to transmit the at least two RF signals, and wherein the structure is configured to couple the at least two RF signals from the at least one package-internal transmission structure to the at least two modes of the package-external waveguide and/or vice versa.
Example 15 is an RF device of Example 14, wherein: the structure comprises the package-internal transmission structure, a package-internal waveguide is coupled to the at least one RF chip, and the package-internal waveguide is configured to transmit the at least two RF signals based on at least two orthogonal modes of the package-internal waveguide.
Example 16 is an RF device of Example 15, wherein the package-internal waveguide comprises at least one of a substrate integrated waveguide or an air-filled waveguide.
Example 17 is an RF device of any of Examples 14 to 16, wherein: the package-internal transmission structure comprises at least two package-internal transmission lines coupled between the at least one RF chip and the structure, wherein the at least two transmission lines are configured to transmit the at least two RF signals.
Example 18 is an RF device of any of the preceding Examples, wherein the package-external waveguide comprises at least one of a metal waveguide, a substrate integrated waveguide, an air-filled waveguide, a dielectric waveguide, a plastic microwave fiber.
Example 19 is a waveguide antenna, comprising: a structure configured to couple at least two RF signals associated with at least two different antenna elements of the waveguide antenna to at least two modes of a waveguide of the waveguide antenna and/or vice versa, wherein the at least two modes are orthogonal to each other, and wherein the waveguide antenna is configured to transmit and/or receive the at least two RF signals with a same electromagnetic polarization.
Example 20 is a waveguide antenna of Example 19, wherein: the waveguide antenna comprises an air-filled plastic waveguide antenna, and the at least two antenna elements comprise at least two slots.
Example 21 is a system, comprising: an RF device according to any of Examples 1 to 18, wherein the RF device is coupled to a first end of the package-external waveguide; and a further structure coupled to a second end of the package-external waveguide, wherein the further structure is configured to couple at least two further RF signals to at least two modes of the package-external waveguide and/or vice versa.
Example 22 is a system of Example 21, wherein the package-external waveguide comprises a waveguide antenna.
Example 23 is a system of Example 21 or 22, further comprising: a printed circuit board arranged between the waveguide and the RF device, wherein the printed circuit board comprises an opening configured for transferring the at least two orthogonal modes between the RF device and the package-external waveguide.
Example 24 is a method for manufacturing an RF device, the method comprising: coupling at least one RF chip and a structure; and integrating the at least one RF chip and the structure in a same semiconductor package, wherein the structure is configured to couple at least two RF signals of the at least one RF chip to at least two modes of a package-external waveguide and/or vice versa, and wherein the at least two modes are orthogonal to each other.

Although specific examples have been illustrated and described herein, it will be appreciated by those of ordinary skill in the art that a variety of alternate and/or equivalent implementations may be substituted for the specific examples shown and described without departing from the scope of the present implementation. This application is intended to cover any adaptations or variations of the specific examples discussed herein. Therefore, it is intended that this implementation be limited only by the claims and the equivalents thereof.

It should be noted that the methods and devices including its preferred implementations as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the implementation and are included within its spirit and scope. Furthermore, all examples and implementations outlined in the present document are principally intended expressly to be only for explanatory purposes to help the reader in understanding the principles of the proposed methods and systems. Furthermore, all statements herein providing principles, aspects, and implementations of the implementation, as well as specific examples thereof, are intended to encompass equivalents thereof.

1. A radio frequency (RF) device, comprising:
at least one RF chip; and
a structure coupled to the at least one RF chip, wherein the at least one RF chip and the structure are integrated in a semiconductor package,
wherein the structure is configured to couple at least two RF signals of the at least one RF chip to at least two modes of a package-external waveguide and/or vice versa, and
wherein the at least two modes are orthogonal to each other.

2. The RF device of claim 1, wherein the structure comprises a combiner configured to combine the at least two RF signals of the at least one RF chip to a combined signal and a launcher configured to couple the combined signal to the at least two modes of the package-external waveguide and/or vice versa.

3. The RF device of claim 1, wherein the at least two RF signals are associated with at least two different RF channels of the at least one RF chip.

4. The RF device of claim 1, wherein the at least two modes comprise at least two orthogonal electromagnetic polarizations of the package-external waveguide.

5. The RF device of claim 1, wherein the structure comprises:
a first antenna configured to transmit and/or receive a first RF signal having a first electromagnetic polarization, and
a second antenna configured to transmit and/or receive a second RF signal having a second electromagnetic polarization orthogonal to the first electromagnetic polarization.

6. The RF device of claim 5, wherein:
the first antenna is formed in a first metal layer arranged at a first main surface of the semiconductor package, and
the second antenna is formed in a second metal layer arranged at a second main surface of the semiconductor package opposite the first main surface.

7. The RF device of claim 5, wherein a geometric shape of the first antenna is complementary to a geometric shape of the second antenna.

8. The RF device of claim 5, wherein the first antenna and the second antenna are formed in an electrical redistribution structure of the semiconductor package.

9. The RF device of claim 5, wherein the semiconductor package is a fan-out wafer level package and the first antenna and the second antenna are arranged in a fan-out area of the fan-out wafer level package.

10. The RF device of any of claim 5, wherein the first antenna comprises a first Vivaldi antenna and the second antenna comprises a second Vivaldi antenna.

11. The RF device of claim 1, wherein the structure comprises:
a first probe antenna configured to excite a first electromagnetic polarization of the package-external waveguide; and
a second probe antenna arranged orthogonal to the first probe antenna and configured to excite a second electromagnetic polarization of the package-external waveguide orthogonal to the first electromagnetic polarization.

12. The RF device of claim 1, wherein the structure comprises:
a patch antenna configured to excite a first electromagnetic polarization of the package-external waveguide and to excite a second electromagnetic polarization of the package-external waveguide orthogonal to the first electromagnetic polarization.

13. The RF device of claim 1, wherein the structure comprises:
a slot antenna comprising a first slot and a second slot arranged orthogonal to the first slot.

14. The RF device of claim 1, further comprising:
at least one package-internal transmission structure coupled between the at least one RF chip and the structure,
wherein the at least one package-internal transmission structure is configured to transmit the at least two RF signals, and
wherein the structure is configured to couple the at least two RF signals from the at least one package-internal transmission structure to the at least two modes of the package-external waveguide and/or vice versa.

15. The RF device of claim 14, further comprising:
a package-internal waveguide is coupled to the at least one RF chip,
wherein the structure comprises the package-internal transmission structure, and
wherein the package-internal waveguide is configured to transmit the at least two RF signals based on at least two orthogonal modes of the package-internal waveguide.

16. The RF device of claim 15, wherein the package-internal waveguide comprises at least one of a substrate integrated waveguide or an air-filled waveguide.

17. The RF device of claim 14, wherein:
the package-internal transmission structure comprises at least two package-internal transmission lines coupled between the at least one RF chip and the structure, wherein the at least two package-internal transmission lines are configured to transmit the at least two RF signals.

18. The RF device of claim 1, wherein the package-external waveguide comprises at least one of a metal waveguide, a substrate integrated waveguide, an air-filled waveguide, a dielectric waveguide, or a plastic microwave fiber.

19. A waveguide antenna, comprising:
a structure configured to couple at least two RF signals associated with at least two different antenna elements of the waveguide antenna to at least two modes of a waveguide of the waveguide antenna and/or vice versa,
wherein the at least two modes are orthogonal to each other, and
wherein the waveguide antenna is configured to transmit and/or receive the at least two RF signals with a same electromagnetic polarization.

20. The waveguide antenna of claim 19, wherein:
the waveguide antenna comprises an air-filled plastic waveguide antenna, and
the at least two different antenna elements comprise at least two slots.

21. A system, comprising:
an RF device according to claim 1, wherein the RF device is coupled to a first end of the package-external waveguide; and
a further structure coupled to a second end of the package-external waveguide, wherein the further structure is configured to couple at least two further RF signals to at least two modes of the package-external waveguide and/or vice versa.

22. The system of claim 21, wherein the package-external waveguide comprises a waveguide antenna.

23. The system of claim 21, further comprising:
a printed circuit board arranged between the waveguide and the RF device, wherein the printed circuit board comprises an opening configured for transferring the at least two modes between the RF device and the package-external waveguide.

24. A method for manufacturing an RF device, the method comprising:
coupling at least one RF chip and a structure; and
integrating the at least one RF chip and the structure in a same semiconductor package,
wherein the structure is configured to couple at least two RF signals of the at least one RF chip to at least two modes of a package-external waveguide and/or vice versa, and
wherein the at least two modes are orthogonal to each other.
